(19) United States
(12) Patent Application Publication
(10) Pub. No.: US 2023/0058746 A1
(43) Pub. Date: Feb. 23, 2023

(54) COATING COMPOSITION COMPRISING A POLY(ETHYLENE-ACRYLATE) COPOLYMER AND METHOD OF COATING SUBSTRATES

(71) Applicant: BASF Coatings GmbH, Münster (DE)

(72) Inventors: Takeshi Tsunoda, Yokohama-shi (JP); Kei Hattori, Yokohama-shi (JP); Ivette Garcia Castro, Ludwigshafen (DE); Werner-Alfons Jung, Ascheberg (DE); Cathrin Corten, Münster (DE)

(21) Appl. No.: 17/758,798

(22) PCT Filed: Jan. 11, 2021
(86) PCT No.: PCT/EP2021/050345

§ 371 Date: Jul. 13, 2022

(30) Foreign Application Priority Data
Jan. 16, 2020 (EP) 20152110.1

(51) Int. Cl. C09D 123/08

(52) U.S. Cl. CPC C09D 123/0884

(57) ABSTRACT

Described herein are coating compositions including at least one specific ethylene copolymer as binder and at least one crosslinking agent. Also described herein is a method of coating substrates with such coating compositions and coated substrates obtained by said method. Also described herein is a method of using such coating compositions for improving the elongation and scratch resistance of coating layers.

The present invention relates to coating compositions, particularly clearcoat compositions, comprising at least one specific ethylene copolymer as binder and at least one crosslinking agent, a method of coating substrates with such coating compositions and coated substrates obtained by said method. Moreover, the present invention relates to the use of such coating compositions for improving the elongation and scratch resistance of coating layers, particularly clearcoat layers.

### STATE OF THE ART

Basecoat/clearcoat (pigmented coating overlaid with a clearcoat layer) finishes for vehicles, such as automobiles and trucks, are currently being widely used. Typically, such finishes are produced by a wet-on-wet method. In the method for applying a basecoat/clearcoat finish, a basecoat (commonly referred to as a color coat) containing color pigments and/or special effect imparting pigments, is applied and flash dried for a short period of time, but not cured. Then the clear coating composition, which provides protection for the color coat and improves the gloss, distinctness of image and overall appearance of the finish, is applied thereover and both the color coat and the clearcoat are cured together. Optionally, the basecoat can be dried and cured before application of the clearcoat.

Scratching and marring of the clearcoat finish continue to be a problem for vehicle finishes. Clearcoat finishes on automotive vehicles are often subjected to mechanical damage caused by a variety of events during normal use. For example, materials that come in contact with the clearcoats under normal use on the roadways, such as stones, sand, metal objects and the like, cause chipping of the clearcoat finish. Keys used to lock and unlock vehicle doors, automated car wash equipment and brushes as well as the placement of sliding objects on the surface of an automotive vehicle such as the top of a trunk or hood causes scratches and marring. Also, the clearcoat finish is subject to environmental damage caused, for example, by acid rain and exposure to UV light.

Typically, a harder more highly crosslinked film may exhibit improved scratch resistance, but it is less flexible and much more susceptible to chipping or thermal cracking due to embrittlement of the film resulting from a high crosslink density. A softer, less crosslinked film, while not prone to chipping or thermal cracking, is susceptible to scratching, waterspotting, and acid etch due to a low crosslink density of the cured film.

Further, elastomeric automotive parts and accessories, for example, elastomeric bumpers and hoods, are typically coated “off-site” and shipped to automobile assembly plants. The coating compositions applied to such elastomeric substrates are typically formulated to be very flexible so the coating can bend or flex with the substrate without cracking. To achieve the requisite flexibility, coating compositions for use on elastomeric substrates often are formulated to produce coatings with lower crosslink densities or such coating compositions include flexibilizing adjuvants which lower the overall film glass transition temperature (T_{g}). While acceptable flexibility properties can be achieved with these formulating techniques, they also can result in softer films that are susceptible to scratching. Consequently, great expense and care must be taken to package the coated parts to prevent scratching of the coated surfaces during shipping to automobile assembly plants.

Despite recent improvements in the scratch resistance of clearcoat systems, there remains a need in the automotive coatings art for clearcoats to have good initial scratch resistance as well as enhanced post-weathering (“retained”) scratch resistance without embrittlement of the film due to high crosslink density. Moreover, it would be advantageous to provide clearcoats for elastomeric substrates utilized in the automotive industry which are both flexible and resistant to scratching.

### OBJECT

Accordingly, the object of the present invention is to provide a coating composition suitable as clear coating composition in OEM finishes and automotive refinishes, which results in coating layers having improved car washing scratch resistance, resistance to humidity, solvent (i.e. gasoline) resistance and high flexibility, while at the same time maintaining a good overall appearance. Accordingly, the aim is to provide a coating composition that ensures a high scratch and solvent resistance as well as a high flexibility while at the same time allowing to form a network with a high degree of weathering stability. In addition, the coating compositions should already have a high degree of scratch resistance immediately after thermal curing and in particular form coating layers having a high level of gloss retention after scratch exposure. In addition, coatings and coating systems, in particular clearcoat systems, should be able to be formed even with film thicknesses greater than 40 μm without generating stress cracks. This is an important requirement for the use of coatings and coating systems, in particular clearcoat systems, in the technical and aesthetically demanding fields of automotive OEM finishing and refinishing. Furthermore, the new coating compositions ought to be easily preparable with very good reproducibility and ought to have a high storage stability.

### TECHNICAL SOLUTION

The objects described above are achieved by the subject matter claimed in the claims and also by the preferred embodiments of that subject matter that are described in the description hereinafter.

A first subject of the present invention is therefore a coating composition comprising:
a) at least one binder B containing an ethylene copolymer, said ethylene copolymer comprising—in polymerized form and based on the total amount of the ethylene copolymer—
   i. 10 to 80 wt. % of ethylene;
   ii. 1 to 90 wt. % of at least one polymerizable compound C1 having at least one hydroxyl group and/or 1 to 80 wt. % of at least one polymerizable compound C2 having at least one epoxide group; and
   iii. 0 to 80 wt. % of at least one further polymerizable compound C3 different from compounds C1 and C2; and
b) at least one crosslinking agent CA comprising at least one reactive functional group which is able to undergo crosslinking reactions with complementary reactive functional groups present in the at least one binder B

The above-specified coating composition is hereinafter also referred to as coating composition of the invention and accordingly is a subject of the present invention. Preferred embodiments of the coating composition of the invention are apparent from the description hereinafter and also from the dependent claims.

In light of the prior art it was surprising and unforeseeable for the skilled worker that the object on which the invention is based could be achieved by using a specific ethylene copolymer as binder in combination with a crosslinking agent having suitable complementary reactive groups in the coating composition. The use of the specific ethylene copolymer results coating compositions which provide coating layers having an improved car washing scratch resistance, resistance to humidity, solvent (i.e. gasoline) resistance and flexibility as compared to coating layers being prepared from coating compositions comprising (meth)acrylic resins. Additionally, the coating compositions allow to prepare coating layers in high film thicknesses of more than 40 μm without the occurrence of stress cracks, thus rendering them especially suitable for OEM automotive finishing applications. Moreover, the inventive coating compositions can be easily prepared and show a high storage stability.

A further subject of the present invention is a method for producing at least one coating on a substrate, comprising
(1) optionally applying a pigmented basecoat composition to the substrate, forming a coating film from said basecoat composition and optionally curing said basecoat film;
(2) applying an inventive coating composition to the substrate or the coated substrate obtained after step (1);
(3) forming a coating film from the composition applied in step (2); and
(4) curing the coating film(s) obtained after step (1) and/or (3).

Another subject of the present invention is a coating obtained by the inventive method.

A final subject of the present invention is the use of an inventive coating composition for improving the elongation and scratch resistance of coating layers, especially of clearcoat layers.

### DETAILED DESCRIPTION

The measurement methods to be employed in the context of the present invention for determining certain characteristic variables can be found in the Examples section. Unless explicitly indicated otherwise, these measurement methods are to be employed for determining the respective characteristic variable. Where reference is made in the context of the present invention to an official standard without any indication of the official period of validity, the reference is implicitly to that version of the standard that is valid on the filing date, or, in the absence of any valid version at that point in time, to the last valid version.

The term “ethylene copolymer” refers to polymers derived from ethylene and at least one further monomer which can be polymerized with ethylene under suitable reaction conditions. Preferably, said at least one further monomer therefore contains at least one unsaturated moiety. Consequently, the term “polymerizable compound” in connection with compounds C1 to C3 refers to a compound, preferably a monomer, which can be polymerized with ethylene under suitable reaction conditions. Preferably, said compounds C1 to C3 therefore each contain at least one unsaturated moiety.

The term “crosslinking agent” refers to compounds having at least one functional group, preferably isocyanate groups, with can undergo a chemical reaction with the functional groups present in the binder B, preferably hydroxyl groups or epoxide groups, under suitable reaction conditions, thus leading to a crosslinking of the binder.

The term “(meth)acrylate” refers both to acrylates and to methacrylates. (Meth)acrylates may therefore be composed of acrylates and/or methacrylates and may comprise further ethylenically unsaturated monomers such as styrene or acrylic acid, for example.

All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

All temperatures elucidated in the context of the present invention should be understood as the temperature of the room in which the substrate or the coated substrate is located. It does not mean, therefore, that the substrate itself is required to have the temperature in question. If room temperature is denoted in the following, this should be understood as a temperature ranging from 20 to 25° C.

Inventive Coating Composition:

Binder B:

The inventive coating composition comprises as first mandatory component (a) at least one binder B, comprising at least one specific ethylene copolymer. With preference, the at least one binder B is consisting of the ethylene copolymer. The term “binder” in the sense of the present invention and in agreement with DIN EN ISO 4618 (German version, date: March 2007), refers preferably to those nonvolatile fractions of the composition of the invention that are responsible for forming the film, with the exception of any pigments and fillers therein, and more particularly refers to the polymeric resins which are responsible for film formation.

Said ethylene copolymer comprises—in polymerized form—
i. 10 to 80 wt. % of ethylene;
ii. 1 to 90 wt. % of at least one polymerizable compound C1 having at least one hydroxyl group and/or 1 to 80 wt. % of at least one polymerizable compound C2 having at least one epoxide group; and
iii. 0 to 80 wt. % of at least one further polymerizable compound C3 different from compounds C1 and C2.

Where it is stated in the context of the present invention that the ethylene copolymer comprises components i., ii. and optionally iii. in polymerized form, this means that these particular components are used as starting compounds for the preparation of the ethylene copolymer in question. Since ethylene can be polymerized with further monomers comprising unsaturated moieties, the ethylene copolymer preferably comprises the unsaturated moieties, previously present in ethylene and the further monomer(s), in the form of C—C single bonds, in other words in their correspondingly reacted form. Accordingly, for the sake of clarity, it is stated that the respective copolymer comprises the components, in each case in polymerized form. The meaning of the expression “the ethylene copolymer comprises, in polymerized form, a component (X)” can therefore be equated with the meaning of the expression “component (X) was used in the course of the preparation of the ethylene copolymer as a monomeric compound”

The ethylene copolymer is preferably prepared in a continuous high-pressure polymerization process. The term “high-pressure continuous polymerization process” refers, in the context of this invention”, to a polymerization process comprising a continuous feed of the starting materials i., ii., optionally iii. and optionally at least one chain transfer agent and/or solvent listed below (also called monomer feed hereinafter) and a continuous output of the produced ethylene copolymer at a pressure of 1,000 to 4,000 bar. The polymerization process may continue for at least 3 h, preferably at least 24 h, and in particular at least 72 h.

The polymerization process may be carried out in stirred high-pressure autoclaves, hereinafter also referred to as high-pressure autoclaves, or in high-pressure tube reactors, hereinafter also referred to as tube reactors. Preference is given to the high-pressure autoclaves, which may have a length/diameter ratio in the range from 5:1 to 30:1, preferably from 10:1 to 20:1.

The polymerization process may be carried out at a pressure in the range from 1,000 to 4,000 bar, preferably from 1,200 to 2,500 bar, and particularly 1,500 to 2,200 bar. It is possible to change the pressure during the polymerization either gradually or suddenly. In case the pressure is changed, however, the pressure is still kept within the afore-stated ranges.

The polymerization process may be carried out at a reaction temperature in the range of 150 to 300° C., preferably 170 to 250° C., and in particular 190 to 230° C.

The monomer feed comprises the ethylene, the at least one polymerizable compound C1 and/or C2 and optionally the at least one polymerizable compound C3. The ethylene, compounds C1 and/or C2, optionally compound C3 and further compounds and solvents listed below can be mixed before, during, or after entering the high-pressure autoclaves or the high-pressure tube reactors. Preferably, ethylene, compounds C1 and/or C2, optionally compound C3 and the chain transfer agent listed below are mixed before entering the high-pressure autoclaves. Typically, the polymerization process takes place in the polymerization zone, which is usually inside the high-pressure autoclave or the high-pressure tube reactor. Mixing of the aforestated compounds and solvents before entering the high-pressure autoclave or reactor can be performed in the middle zone pressure of 200 to 300 bar and is called mixing within the compressor. Mixing within the compressor results in an increased homogeneity of the obtained mixture. Alternatively, all liquid compounds (i.e. compressed liquid ethylene, compounds C1 and/or C2, optionally C3, chain transfer agent and solvents) can be directly added to the high-pressure zone of 1,000 to 4,000 bar (called mixing outside of the compressor). In addition, both ways to add the liquids components can be used simultaneously.

Preferably, the monomer feed is free of an initiator, preferably free of an initiator suitable for radical polymerization as listed below.

The monomer feed comprises the ethylene, compound C1 and/or C2 and optionally C3 in amounts which are suitable to arrive at the amounts previously listed in connection with the ethylene copolymer.

Usually, the monomer feed comprises at least 30 wt. %, preferably at least 40 wt. %, and in particular at least 50 wt. % of ethylene, based in each case on the total weight of the monomer feed. In another form, the monomer feed comprises 30 to 95 wt. %, preferably 40 to 90 wt. %, and in particular 50 to 70 wt. % or from 70 to 85 wt. % of ethylene, based on the total weight of the monomer feed.

Usually, the monomer feed comprises at least 10 wt. %, preferably at least 25 wt. %, and in particular at least 35 wt. % of polymerizable compound C1 comprising at least one hydroxy group, where the percentage is based on the total weight of the monomer feed. In another form the monomer feed comprises at least 5 wt. %, preferably at least 8 wt. %, and in particular at least 12 wt. % of polymerizable compound C1 comprising at least one hydroxy group, where the percentage is based on the total weight of the monomer feed. In another form, the monomer feed comprises 10 to 70 wt. %, preferably 20 to 60 wt. %, and in particular 36 to 55 wt. % of polymerizable compound C1 comprising at least one hydroxy group. In another form, the monomer feed comprises 5 to 60 wt. %, preferably 8 to 45 wt. %, and in particular 12 to 35 wt. % of polymerizable compound C1 comprising at least one hydroxy group.

Usually, the monomer feed comprises at least 10 wt. %, preferably at least 25 wt. %, and in particular at least 35 wt. % of polymerizable compound C2 comprising at least one epoxy group, where the percentage is based on the total weight of the monomer feed. In another form the monomer feed comprises at least 5 wt. %, preferably at least 8 wt. %, and in particular at least 12 wt. % of polymerizable compound C2 comprising at least one epoxy group, where the percentage is based on the total weight of the monomer feed. In another form, the monomer feed comprises 10 to 70 wt. %, preferably 20 to 60 wt. %, and in particular 30 to 50 wt. % of polymerizable compound C2 comprising at least one epoxy group. In another form, the monomer feed comprises 5 to 60 wt. %, preferably 8 to 45 wt. %, and in particular 12 to 35 wt. % of polymerizable compound C2 comprising at least one epoxy group.

The monomer feed may comprise up to 10% wt., preferably up to 20% wt., more preferably up to 30% wt., very preferably up to 40% wt., of polymerizable compound C3, where the percentage is based on the total weight of the monomer feed. In another form, the monomer feed comprises 5 to 70 wt. %, preferably 10 to 60 wt. %, and in particular 15 to 55 wt. % of polymerizable compound C3.

The conversion of the ethylene is usually around 10to 50 wt. %, preferably 25 to 45 wt. % and in particular 30 to 45 wt., based in each case on the ethylene feed and temperature of the reaction

The polymerization of the monomer feed comprising ethylene, compound C1 and/or C2 and optionally C3 is usually carried out in the presence of at least one chain transfer agent. Suitable chain transfer agents in the sense of this invention are compounds which terminate the polymerization reaction by being incorporated as terminus of the copolymer chain. Suitable chain transfer agents are selected from saturated or unsaturated hydrocarbons, aliphatic ketones, aliphatic aldehydes, hydrogen, or mixtures thereof. The term “aliphatic” as used herein includes the term “cycloaliphatic” and refers to non-aromatic groups, moieties and compounds, respectively.

Among saturated and unsaturated hydrocarbons the chain transfer agents can be selected from pentane, hexane, cyclohexane, isododecane, propene, butene, pentene, cyclohexene, hexene, octene, decen and dodecen, and from aromatic hydrocarbons such as toluene, xylol, trimethyl-benzene, ethylbenzene, diethylbenzene, triethylbenzene, mixtures thereof.

Suitable ketones or aldehydes as chain transfer agents are aliphatic aldehydes or aliphatic ketones, such as compounds of general formula (I)

R¹—C(O)—R² (I)

wherein

R¹ and R² are, independently from each other selected from
hydrogen;
C₁-C₆-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl and sec-hexyl groups, more preferably C₁-C₄-alkyl groups such as methyl, ethyl, n-propyl, isopropyl, n-butyl, isobutyl, sec-butyl and tert-butyl groups; or
C₃-C₁₂-cycloalkyl groups such as cyclopropyl, cyclobutyl, cyclopentyl, cyclohexyl, cycloheptyl, cyclooctyl, cyclononyl, cyclodecyl, cycloundecyl and cyclododecyl groups, more preferably cyclopentyl, cyclohexyl and cycloheptyl groups.

The R¹ and R² residues may also be covalently bonded to one another to form a 4- to 13-membered ring. For example, R¹ and R² may form the following alkylene groups: —(CH₂)₄—, —(CH₂)₅—, —(CH₂)₆—, —(CH₂)₇—, —CH(CH₃)—CH₂—CH₂—CH(CH₃)— or —CH(CH₃)—CH₂—CH₂—CH₂—CH(CH₃)—.

Preferred ketones as chain transfer agents are acetone, methylethylketone, diethylketone and diamylketone. Preferred aldehydes as chain transfer agents are acetaldehyde, propionaldehyde, butanal and pentanal.

Among alcohols the chain transfer agents are selected from the group consisting of methanol, ethanol, propanol, isopropanol, butanol and pentanol.

Among thiols the chain transfer agents maybe selected from mercaptoethanol to tetrade-canthiol. In another form suitable thiols are organic thio compounds, such as primary, secondary, or tertiary aliphatic thiols, such as, ethanethiol, n-propanethiol, 2-propanethiol, n-butanethiol, tert-butanethiol, 2-butanethiol, 2-methyl-2-propanethiol, n-pentanethiol, 2-pen-tanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as 2-hydroxyethanethiol, aromatic thiols, such as benzenethiol, ortho-, meta-, or para-methyl-benzenethiol, mercaptoalkanoic acid and derivatives thereof, such as 6-methylheptyl 3-mercaptopropionate or 2-ethylhexyl 2-mercaptoethanoate.

Among amines the chain transfer agents are selected from primary, secondary, or tertiary amines, such as dialkyl amines or trialkyl amines. Examples for amines are propyl amine, dipropyl amine, dibutyl amine, triethyl amine.

Preferred chain transfer agents are aliphatic aldehydes and/or aliphatic ketones and/or hydrogen. Particularly preferred chain transfer agents are propionaldehyde and/or methylethylketone and/or hydrogen.

The weight ratio of propionaldehyde to methylethylketone may be in the range from 4:1 to 1:4, preferably from 3.5:1 to 1:3.0, in particular from 2.8:1 to 1:2.5

In another form the monomer feed comprising the ethylene and the compound C1 and/or C2 and optionally C3 may be polymerized in the presence of at least 2 wt. % of chain transfer agent, based on the total weight of the monomer feed. The chain transfer agent may be used in amounts of 4 to 28 wt. %, preferably 6 to 23 wt. %, and in particular 9 to 13 wt. % or 13 to 20 wt. %, based in each case on the total weight of the monomer feed.

The chain transfer agents can be diluted with suitable solvents (e.g. hydrocarbons), preferably they are used without additional solvents.

The polymerization process is usually a free-radical polymerization and thus initiated by an initiator. Suitable initiators are organic peroxides, oxygen or azo compounds. Mixtures of a plurality of free-radical initiators are also suitable.

Suitable peroxides are didecanoyl peroxide, 2,5-dimethyl-2,5-di(2-ethylhexanoylperoxy)hexane, tert-amyl peroxypivalate, tert-amyl peroxy-2-ethylhexanoate, dibenzoyl peroxide, tert-butyl peroxy-2-ethylhexanoate, tert-butyl peroxydiethylacetate, tert-butyl peroxydiethylisobutyrate, 1, 4-di(tert-butylperoxycarbonyl)cyclohexane as isomer mixture, tert-butyl perisononanoate, 1, 1-di(tert-butylperoxy)-3,3,5-trimethylcyclohexane, 1,1-di(tert-butylperoxy)cyclo-hexane, methyl isobutyl ketone peroxide, tert-butyl peroxyisopropylcarbonate, 2,2-di(tert-butylperoxy)butane or tert-butyl peroxacetate; tert-butyl peroxybenzoate, di-tert-amyl peroxide, dicumyl peroxide, the isomeric di-(tert-butylperoxyisopropyl)benzenes, 2,5-dimethyl-2,5-di-tert-butylperoxyhexane, tert-butyl cumyl peroxide, 2,5-dimethyl-2,5-di(tert-butylperoxy)hex-3-yne, di-tert-butylperoxide, 1,3-diisopropylbenzene monohydroperoxide, cumene hydroperoxide or tert-butyl hydro-peroxide, or dimeric or trimeric ketone peroxides.

As azo compound azodicarboxylic esters, azodicarboxylic dinitriles are suitable, mention may be made by way of example of azobisisobutyronitrile (“AIBN”).

Preferred initiators are selected from the group consisting of di-tert-butyl peroxide, tert-amyl peroxypivalate, tert-butyl peroxypivalat, tert-butyl peroxyisononanoate, tert-butyl peroxy-2-ethylhexanoate, 2,2-di(tert-butylperoxy)butane and mixtures thereof. Preferably tert-amyl peroxypivalate is used as initiator.

Initiators, e.g. organic peroxides, are often mixed with solvents to make them easier to handle. In a preferred form the initiator is introduced in the form of a solution in one or more ketone(s) or hydrocarbons (especially olefins) which are liquid at room temperature. The initiator is preferably fed in as a 0.1 to 50% strength by weight solution, preferably a 0.5 to 20% strength by weight solution, in one or more hydrocarbons or one or more ketone(s) which are liquid at room temperature, mixtures of hydrocarbons (e.g. olefins or aromatic hydrocarbons such as toluene, ethylbenzene, ortho-xylene, meta-xylene and para-xylene, also cycloaliphatic hydrocarbons such as cyclohexane and aliphatic C₆-C₁₆-hydrocarbons, either branched or unbranched, for example n-heptane, n-octane, isooctane, n-decane, n-dodecane and in particular isododecane) or ketones (e.g. acetone, methyl isobutyl ketone, ethyl methyl ketone). In cases where the solvents for the initiator also function as chain transfer agents (for example ketones), the amount of said solvent is taken into account when calculating the amount of the chain transfer agent in the monomer feed.

The amount of the initiator depends on the chemical nature of the initiator and can by adjusted by routine experiments. Typically, the initiator is present in 0.001 to 0.1 wt. %, preferably 0.01 to 0.05 wt. % based in each case on the total weight of the monomer feed.

The initiators employed herein can be introduced into the polymerization zone in any suitable manner, for example, by dissolving the initiator in a suitable solvent and injecting the initiator solution directly into the polymerization zone. Alternatively, the initiator may be injected into the ethylene feed stream or the feed stream containing compound C1 and/or C2 and optionally C3, prior to introduction thereof into the polymerization zone. The initiator can, for example, be fed in at the beginning, in the middle or after one third of the tube reactor. Initiator can also be fed in at a plurality of points on the tube reactor. The initiator can either be fed in at one point in the middle of the autoclave or in the upper part and the middle or bottom of the autoclave. In addition, three or more injections are possible.

The polymerization process may be followed by post polymerization reactions, such as a hydrogenation. The hydrogenation may be a homogeneous or heterogenous catalytic hydrogenation. Usually, the hydrogenation is achieved with molecular hydrogen in the presence of a transition metal catalyst (e.g. based on Rh, Co, Ni, Pd, or Pt), which may be dissolved in solvents or supported on inorganic supports.

The ethylene copolymer is usually not crystalline, so that in general no crystallization commencement temperature (T_{CC}) is measurable at T>15° C. with differential scanning calorimetry. Usually, a melt flow index cannot be determined for the ethylene copolymer.

The ethylene copolymer may have a pour point below 25° C., preferably below 20° C., and in particular below 15° C., as determined according to ASTM D 97-05. Due to this low pour point, the ethylene copolymer is liquid at room temperature, thus allowing an easy incorporation of said ethylene copolymer as binder in coating compositions preferably having a viscosity of less than 1,000 mPa*s at 23° C. (determined according to JIS Z8803:2011 with a Brookfield viscometer BM type from TOKYO KEIKI INC using a full scale torque of 67.4 μN*m), e.g. being liquid at room temperature (i.e. at 20 to 25° C.).

If the ethylene copolymer contains at least one compound C1 having at least one hydroxyl group, it preferably has a hydroxyl number of more than 50 mg KOH/g solids. This large hydroxyl number allows to achieve a sufficient degree of crosslinking and scratch-resistance with the crosslinking agent CA without negatively influencing the high flexibility of the resulting coating layer. Preferably, the ethylene copolymer has a hydroxyl number from 50 to 250 mg KOH/g solids, preferably from 50 to 200 mg KOH/g solids, very preferably 100 to 200 mg KOH/g solids, as determined according to JIS K 0070:1992.

The ethylene copolymer preferably has a weight-average molecular weight M, from 1,000 to 30,000 g/mol, more preferably from 1,500 to 15,000 g/mol, very preferably 3,000 to 10,000 g/mol, as determined by gel-permeation chromatography using polystyrene standards. The number-average molecular weight Mₙ of the ethylene copolymer is preferably in the range from 1,000 to 12,000 g/mol, preferably from 1,200 to 9,000 g/mol, more preferably from 1500 to 7000 g/mol, very preferably from 1,700 to 5,000 g/mol. The Mₙ can be determined as previously described in connection with the M_{w}.

The ethylene copolymer usually has a polydispersity PD (M_{w}/Mₙ) of 1.5 to 3, preferably 1.7 to 2.5. In another form the ethylene copolymer usually has a polydispersity PD in the range from 2.7 to 4.5, more preferably from 3.0 to 4.0, and most preferably from 3.2 to 3.8.

The ethylene copolymer preferably has a kinematic viscosity at 120° C. (V120) of 10 to 6,000 mm²/s (cst), preferably 40 to 4,000 mm²/g (cst), very preferably 70 to 2,300 mm²/g (cst), as determined according to ASTM D 445-2018.

The ethylene copolymer may comprise—in polymerized form and based in each case on the total weight of the ethylene copolymer—from 20 to 70 wt. %, preferably from 25 to 65 wet %, more preferably from 30 to 60 wt. %, of ethylene, as determined by ¹H-NMR.

The at least one polymerizable compound C1 comprising at least one hydroxyl group is preferably selected from hydroxyl group-containing (meth)acrylates, more preferably from hydroxy C1-C12 alkyl group-containing (meth)acrylates, even more preferably selected from 2-hydroxyethyl (meth)acrylate, 2-hydroxyisopropyl (meth)acrylate, 3-hydroxypropyl (meth)acrylate, hydroxyisobutyl (meth)acrylate and 4-hydroxybutyl (meth)acrylate, very preferably from 2-hydroxyethyl (meth)acrylate.

The ethylene copolymer may comprise—in polymerized form and based in each case on the total weight of the ethylene copolymer—from 1 to 70 wt. %, preferably from 3 to 60 wt. %, more preferably from 7 to 50 wt. %, of at least one polymerizable compound C1 comprising at least one hydroxyl group, preferably 2-hydroxyethyl (meth)acrylate, as determined by ¹H-NMR.

The at least one polymerizable compound C2 comprising at least one epoxide group is preferably selected from glycidyl acrylate and/or glycidyl methacrylate.

The ethylene copolymer may comprise—in polymerized form and based in each case on the total weight of the ethylene copolymer—from 5 to 70 wt. %, preferably from 10 to 60 wt. %, more preferably from 15 to 55 wt. %, of at least one polymerizable compound C2 comprising at least one epoxide group, preferably glycidyl acrylate and/or glycidyl methacrylate, as determined by ¹H-NMR.

The at least one polymerizable compound C3 is preferably selected from alkyl (meth)acrylates, more preferably from C₁-C₂₂ alkyl (meth)acrylates, even more preferably from C₁-C₁₂ alkyl (meth)acrylates such as C₃ alkyl (meth)acrylates, C₄ alkyl (meth)acrylates, C₅ alkyl (meth)acrylates, C₆ alkyl (meth)acrylates, C₇ alkyl (meth)acrylates and C₈ alkyl (meth)acrylates, very preferably from methyl (meth)acrylate and/or n-butyl (meth)acrylate and/or 2-ethylhexyl (meth)acrylate.

The ethylene copolymer may comprise—in polymerized form and based in each case on the total weight of the ethylene copolymer—from 5 to 75 wt. %, preferably from 10 to 70 wt. %, more preferably from 15 to 60 wt. %, of at least one polymerizable compound C3, preferably methyl (meth)acrylate and/or n-butyl (meth)acrylate and/or 2-ethylhexyl (meth)acrylate, as determined by ¹H-NMR.

The following particularly preferred binders are used in the coating composition of the invention:

Binder B-1a comprising, preferably consisting of, an ethylene copolymer comprising—in polymerized form and based in each case on the total weight of the ethylene copolymer:
i. 10 to 80 wt. %, preferably 30 to 60 wt. %, of ethylene,
ii. 1 to 90 wt. %, preferably 7 to 50 wt. %, of at least one compound C1, in particular 2-hydroxyethyl (meth)acrylate, and
iii. 0 to 80 wt. %, preferably 15 to 60 wt. %, of at least one compound C3, in particular methyl (meth)acrylate and/or n-butyl (meth)acrylate and/or 2-ethylhexyl (meth)acrylate.

Binder B-2a comprising, preferably consisting of, an ethylene copolymer comprising—in polymerized form and based in each case on the total weight of the ethylene copolymer:
i. 10 to 80 wt. %, preferably 30 to 60 wt. %, of ethylene,
ii. 1 to 80 wt. %, preferably 15 to 55 wt. %, of at least one compound C2, in particular glycidyl (meth)acrylate, and
iii. 0 to 80 wt. %, preferably 15 to 60 wt. %, of at least one compound C3, in particular methyl (meth)acrylate and/or n-butyl (meth)acrylate and/or 2-ethylhexyl (meth)acrylate.

The coating composition of the invention can comprise exactly one binder B, preferably the afore-described binder B-1 a or B-2a, or it can comprise a mixture of different binders B. In this case, it is preferred if the at least one binder B comprises
at least one binder B-1 containing an ethylene copolymer, said ethylene copolymer comprising—in polymerized form and based in each case on the total weight of the ethylene copolymer—10 to 80 wt. % of ethylene, 1 to 90 wt. % of at least one polymerizable compound C1 having at least one hydroxyl group and 0 to 80 wt. % of at least one further polymerizable compound C3 different from compound C1; and
at least one binder B-2 containing an ethylene copolymer, said ethylene copolymer comprising—in polymerized form and based in each case on the total weight of the ethylene copolymer—10 to 80 wt. % of ethylene, 1 to 80 wt. % of at least one polymerizable compound C2 having at least one epoxide group and 0 to 80 wt. % of at least one further polymerizable compound C3 different from compound C2.

The at least one binder B, in particular the afore-listed specific binders B, are present in the inventive coating composition in a total amount of 10 to 60 wt. %, preferably 15 to 50 wt. %, more preferably 25 to 45 wt. %, very preferably 30 to 40 wt. %, based in each case on the total weight of the coating composition. In case more than one binder B is present, the afore-mentioned amounts are referring to the sum of all binders B being present in the inventive coating composition.

Crosslinking Agent CA:

The second mandatory component of the inventive coating composition is a crosslinking agent CA. Said crosslinking agent CA comprises at least one reactive functional group which is able to undergo crosslinking reactions with complementary reactive functional groups present in the at least one binder B. Since the at least one binder B contains reactive functional groups in the form of hydroxyl or epoxide groups, preferred reactive functional groups which are able to undergo crosslinking reactions with such hydroxyl or epoxide groups are isocyanate groups, amino groups, hydroxyl groups or carbodiimide groups. Preferred combinations of functional groups, accordingly, are selected from
hydroxyl-functional groups in the binder B and isocyanate or carbodiimide-groups in the crosslinking agent CA,
epoxy-functional groups in the binder B and amino or hydroxyl groups in the crosslinking agent CA.

The at least one crosslinking agent CA is preferably selected from blocked and/or unblocked polyisocyanates, melamine resins, polycarbodiim ides, triazines, preferably trialkoxycarbamatotriazine, polyfunctional acid resins and mixtures thereof, more preferably blocked and/or unblocked polyisocyanates.

The inventive coating composition preferably comprises a specific equivalent value of all reactive functional groups present in the at least one crosslinking agent CA to the complementary reactive functional groups in the at least one binder B. This ensures a sufficient crosslinking and reduces reaction of the functional groups of the crosslinker with moisture from the air, which might lead to a negative impact on the optical and mechanical properties of the formed coating layer. The composition preferably comprises an equivalent value of all reactive functional groups present in the at least one crosslinking agent CA to all complementary reactive functional groups present in the at least one binder B of 0.5 to 2.0, more preferably 0.5 to 1.5, very preferably 0.8 to 1.2.

The at least one crosslinking agent CA is preferably present in a total amount of 4 to 40 wt. %, more preferably 5 to 35 wt. %, even more preferably 10 to 30 wt. %, very preferably 12 to 25 wt. %, based in each case on the total weight of the coating composition.

Further Ingredients:

The coating composition according to the invention may contain additional ingredients commonly used in coating compositions.

In order to facilitate crosslinking between the binder B and the crosslinking agent CA, at least one crosslinking catalyst CAT may be contained in the coating composition. The presence of at least one crosslinking catalyst is particularly preferred if a crosslinking agent CA containing blocked or unblocked isocyanate groups is present in the inventive coating composition.

In principle, all commonly known crosslinking catalysts can be used. However, it is preferred if the least one crosslinking catalyst CAT is selected from tin containing catalysts, bismuth containing catalysts, zirconium containing catalysts, lithium containing catalysts and mixtures thereof, preferably dibutyltin dilaurate, bismuth carboxylate, zirconium carboxylate, lithium carboxylate and mixtures thereof.

The at least one crosslinking catalyst CAT, preferably dibutyltin dilaurate, bismuth carboxylate, zirconium carboxylate, lithium carboxylate and mixtures thereof, is preferably present in a total amount of 0.005 to 1 wt. %, more preferably 0.08 to 0.2 wt. %, based in each case on the total weight of the coating composition.

Apart from binder B previously explained in detail, the inventive coating composition can also comprise further binders BF being different from binder B. Suitable binders comprise physically and/or thermally and/or chemically curable binders commonly known to the person skilled in the art. In the context of the present invention, “physically curable” or the term “physical curing” means the formation of a cured coating film through evaporation of solvent from polymer solutions or polymer dispersions, the curing being achieved through interlooping of polymer chains. The term “thermally and chemically curable” means the crosslinking of a paint film (formation of a cured coating film) by chemical reaction of reactive functional groups initiated through thermal energy. This can involve reaction of complementary functional groups and/or the reaction of autoreactive groups, i.e. functional groups which inter-react with groups of the same kind. Examples of suitable complementary reactive functional groups and autoreactive functional groups are known, for example, from German patent application DE 199 30 665 A1, page 7 line 28 to page 9 line 24. Chemical curing also includes curing by radiation using, for example, binders comprising unsaturated bonds optionally in combination with at least one photoinitiator.

The crosslinking may be self-crosslinking and/or external crosslinking. If, for example, the complementary reactive functional groups are already present in an organic polymer used as a binder, for example a polyester, a polyurethane or a poly(meth)acrylate, self-crosslinking is present. External crosslinking is present, for example, when a (first) organic polymer containing particular functional groups, for example hydroxyl groups, reacts with a crosslinking agent known per se, for example a polyisocyanate and/or a melamine resin. The crosslinking agent thus contains reactive functional groups complementary to the reactive functional groups present in the (first) organic polymer used as the binder.

Preferred further binders are selected from hydroxy-functional polymers, such as polyesters, polyethers, poly(meth)acrylates, polyurethanes, polyurethane poly(meth)acrylate copolymers, polyurethane polyurea copolymers, mixtures thereof and copolymers of the stated polymers. A copolymer in the context of the present invention refers to polymer particles formed from different polymers. This explicitly includes both polymers bonded covalently to one another and those in which the different polymers are bound to one another by adhesion. Combinations of the two types of bonding are also covered by this definition. According to a preferred embodiment of the present invention, the coating composition is free of further binders apart from binder B, i.e. the amount of further binders BF being different from binder B is 0 wt. %, based on the total weight of the coating composition.

The coating compositions of the invention may further comprise at least one customary and known coatings additive in typical amounts, i.e., in amounts preferably from 0 to 20 wt.-%, more preferably from 0.005 to 15 wt.-% and particularly from 0.01 to 10 wt.-%, based in each case on the total weight of the coating composition. The before-mentioned weight-percentage ranges apply for the sum of all additives likewise. Said additive can be selected from the group consisting of (i) UV absorbers; (ii) light stabilizers such as HALS compounds, benzotriazoles or oxalanilides; (iii) rheology modifiers such as sagging control agents (urea crystal modified resins), organic thickeners and inorganic thickeners; (iv) free-radical scavengers; (v) slip additives; (vi) polymerization inhibitors; (vii) defoamers; (viii) wetting agents; (ix) fluorine compounds; (x) adhesion promoters; (xi) leveling agents; (xii) film-forming auxiliaries such as cellulose derivatives; (xiii) fillers, such as nanoparticles based on silica, alumina or zirconium oxide; (xiv) flame retardants; and (xv) mixtures thereof.

Particularly preferred additives are UV absorbers, light stabilizers and leveling agents. Suitable UV absorbers and light stabilizers are selected from benzotriazoles, benzophenones, sterically hindered amines, oxalic acid diamines, triazines and mixtures thereof. Particularly suitable leveling agents are selected from polyether modified polymethylalkylsiloxanes.

Depending on the particular crosslinking agent CA present in the coating composition, said composition is configured as a one-component system or is obtainable by mixing two (two-component system) or more (multicomponent system) components. In thermochemically curable one-component systems, the components to be crosslinked, in other words binder and crosslinking agent, are present alongside one another, in other words in one component. A condition for this is that the components to be crosslinked react with one another effectively only at relatively high temperatures, of more than 100° C., for example, so as to prevent premature thermochemical curing during storage. Such a combination may be exemplified by hydroxy-functional polyesters and/or polyurethanes with melamine resins and/or blocked polyisocyanates as crosslinking agents.

In thermochemically curable two-component or multicomponent systems, the components to be crosslinked, in other words binders and the crosslinking agents, are present separately from one another in at least two components, which are combined shortly before the application. This form is selected when the components to be crosslinked react with one another effectively even at ambient temperatures or slightly elevated temperatures of, for example, 40 to 90° C. Such a combination may be exemplified by hydroxy-functional polyesters and/or polyurethanes and/or poly(meth)acrylates with free polyisocyanates as crosslinking agents. Particularly preferred compositions are two-component compositions which have to be mixed prior to application onto the substrate and which preferably comprise the binder B and the crosslinking agent CA in separate containers. In case the composition is obtainable by mixing two or more components, the weight ratio of the binder-containing component to the crosslinker-containing component is preferably from 85:15 to 55:45.

Mixing may take place manually, with the appropriate amount of a first component being introduced into a vessel, admixed with the corresponding quantity of the second component. However, mixing of the two or more components can also be performed automatically by means of an automatic mixing system. Such an automatic mixing system can comprise a mixing unit, more particularly a static mixer, and also at least two devices for supplying the binder containing first component and the crosslinker containing second component, more particularly gear pumps and/or pressure valves.

The inventive coating compositions are preferably clearcoat or tinted clearcoat compositions. Tinted clearcoat composition are, when applied to a substrate, neither completely transparent and colorless as a clear coating nor completely opaque as a typical pigmented coating. A tinted clear coating is therefore transparent and colored or semi-transparent and colored. The color can be achieved by adding at least one pigment and/or dye commonly used in coating compositions. Suitable pigments are, for example, organic and inorganic coloring pigments, effect pigments and mixtures thereof. Such color pigments and effect pigments are known to those skilled in the art and are described, for example, in Römpp-Lexikon Lacke and Druckfarben, Georg Thieme Verlag, Stuttgart, New York, 1998, pages 176 and 451. The terms “coloring pigment” and “color pigment” are interchangeable, just like the terms “visual effect pigment” and “effect pigment”. Suitable inorganic coloring pigments are selected from (i) white pigments, such as titanium dioxide, zinc white, colored zinc oxide, zinc sulfide, lithopone; (ii) black pigments, such as iron oxide black, iron manganese black, spinel black, carbon black; (iii) color pigments, such as ultramarine green, ultramarine blue, manganese blue, ultramarine violet, manganese violet, iron oxide red, molybdate red, ultramarine red, iron oxide brown, mixed brown, spinel and corundum phases, iron oxide yellow, bismuth vanadate; (iv) filer pigments, such as silicon dioxide, quartz flour, aluminum oxide, aluminum hydroxide, natural mica, natural and precipitated chalk, barium sulphate and (vi) mixtures thereof.

Suitable organic coloring pigments are selected from (i) monoazo pigments such as C.I. Pigment Brown 25, C.I. Pigment Orange 5, 36 and 67, C.I. Pigment Orange 5, 36 and 67, C.I. Pigment Red 3, 48:2, 48:3, 48:4, 52:2, 63, 112 and 170 and C.I. Pigment Yellow 3, 74, 151 and 183; (ii) diazo pigments such as C.I. Pigment Red 144, 166, 214 and 242, C.I. Pigment Red 144, 166, 214 and 242 and C.I. Pigment Yellow 83; (iii) anthraquinone pigments such as C.I. Pigment Yellow 147 and 177 and C.I. Pigment Violet 31; (iv) benzimidazole pigments such as C.I. Pigment Orange 64; (v) quinacridone pigments such as C.I. Pigment Orange 48 and 49, C.I. Pigment Red 122, 202 and 206 and C.I. Pigment Violet 19; (vi) quinophthalone pigments such as C.I. Pigment Yellow 138; (vii) diketopyrrolopyrrole pigments such as C.I. Pigment Orange 71 and 73 and C.I. Pigment Red, 254, 255, 264 and 270; (viii) dioxazine pigments such as C.I. Pigment Violet 23 and 37; (ix) indanthrone pigments such as C.I. Pigment Blue 60; (x) isoindoline pigments such as C.I. Pigment Yellow 139 and 185; (xi) isoindolinone pigments such as C.I. Pigment Orange 61 and C.I. Pigment Yellow 109 and 110; (xii) metal complex pigments such as C.I. Pigment Yellow 153; (xiii) perinone pigments such as C.I. Pigment Orange 43; (xiv) perylene pigments such as C.I. Pigment Black 32, C.I. Pigment Red 149, 178 and 179 and C.I. Pigment Violet 29; (xv) phthalocyanine pigments such as C.I. Pigment Violet 29, C.I. Pigment Blue 15, 15:1, 15:2, 15:3, 15:4, 15:6 and 16 and C.I. Pigment Green 7 and 36; (xvi) aniline black such as C.I. Pigment Black 1; (xvii) azomethine pigments; and (xviii) mixtures thereof.

Suitable effect pigments are selected from the group consisting of (i) plate-like metallic effect pigments such as plate-like aluminum pigments, gold bronzes, fire-colored bronzes, iron oxide-aluminum pigments; (ii) pearlescent pigments, such as metal oxide mica pigments; (iii) plate-like graphite pigments; (iv) plate-like iron oxide pigments; (v) multi-layer effect pigments from PVD films; (vi) liquid crystal polymer pigments; and (vii) mixtures thereof.

The tinted clear coating compositions preferably comprises the at least one color and/or effect pigment in a total amount of 0.1 to 10 wt.-%, preferably 1 to 4 wt.-%, based on the total weight of the coating composition.

In contrast, clearcoat compositions do usually not comprise any coloring and/or effect pigments, i.e. the amount of coloring and/or effect pigments is preferably 0 wt.-%, based on the total weight of the coating composition. However, it is likewise possible to add filler materials and matting agents in order to adjust the gloss of the clearcoat materials.

The coating composition according to the invention may be a solvent-based composition or an aqueous composition, preferably a solvent-based composition. In the case of a solvent-based composition, organic solvents are included as a principal constituent, i.e. in amounts of more than 20 wt.-%, more preferably at least 30 wt.-%, based on the total weight of the coating composition. Organic solvents constitute volatile components of the composition and undergo complete or partial vaporization on drying or flashing, respectively. Suitable organic solvents are, for example, ketones such as acetone, methyl ethyl ketone, cyclohexanone, methyl isobutyl ketone, methyl isoamyl ketone or diisobutyl ketone; esters such as ethyl acetate, n-butyl acetate, ethylene glycol diacetate, butyrolactone, diethyl carbonate, propylene carbonate, ethylene carbonate, 2-methoxypropyl acetate (MPA), and ethyl ethoxypropionate; am ides such as N, N-dimethylformam ide, N, N-dimethylacetam ide, N-methylpyrrolidone, and N-ethylpyrrolidone; methylal, butylal, 1,3-dioxolane, glycerol formal. Especially preferred organic solvents are n-butyl acetate and 1-methoxypropyl acetate.

Such solvent-based compositions preferably comprise water in a total amount of 0 to 20 wt. %, preferably 0 to 10 wt. %, more preferably 0 to 5 wt. %, and very preferably 1 to 5 wt. %, based in each case on the total weight of the coating composition.

The at least one solvent, preferably organic solvent, is preferably present in a total amount of 10 to 60% by weight, preferably 20 to 50% by weight, very preferably 30 to 40% by weight, based in each case on the total weight of the coating composition.

The coating composition preferably possesses a solids content of 40 to 60% by weight, very preferably 50% by weight, based on the total weight of the coating composition. Due to the high solid contents of the inventive coating compositions, the amount of organic solvents released during drying and curing is significantly reduced, thus allowing lower VOC values and rendering them environmentally friendly.

Inventive Method:

The present invention is also directed to a method of coating a substrate with the inventive coating compositions in which the inventive coating compositions are applied on the substrate optionally coated with a basecoat film or layer, a coating film is formed form the inventive coating composition and said coating film is afterwards cured.

The substrate is preferably selected from metallic substrates, metallic substrates coated with a cured electrocoat and/or a cured filler, plastic substrates and substrates comprising metallic and plastic components, especially preferably from metallic substrates. In case of metallic and plastic substrates or substrates comprising metallic and plastic components, said substrates may be pretreated before optional step (1) or step (2) of the inventive process in any conventional way—that is, for example, cleaned (for example mechanically and/or chemically) and/or provided with known conversion coatings (for example by phosphating and/or chromating) or surface activating pre-treatments (for example by flame treatment, plasma treatment and corona discharge coming).

In this respect, preferred metallic substrates are selected from iron, aluminum, copper, zinc, magnesium and alloys thereof as well as steel. Preferred substrates are those of iron and steel, examples being typical iron and steel substrates as used in the automobile industry sector. The substrates themselves may be of whatever shape—that is, they may be, for example, simple metal panels or else complex components such as, in particular, automobile bodies and parts thereof.

Preferred plastic substrates are basically substrates comprising or consisting of (i) polar plastics, such as polycarbonate, polyamide, polystyrene, styrene copolymers, polyesters, polyphenylene oxides and blends of these plastics, (ii) synthetic resins such as polyurethane RIM, SMC, BMC, ABS and (iii) polyolefin substrates of the polyethylene and polypropylene type with a high rubber content, such as PP-EPDM, and surface-activated polyolefin substrates. The plastics may furthermore be fiber-reinforced, in particular using carbon fibers and/or metal fibers.

As substrates it is also possible, moreover, to use those which contain both metallic and plastics fractions. Substrates of this kind are, for example, vehicle bodies containing plastics parts.

Metallic substrates comprising a cured electrocoating can be obtained by electrophoretically applying an electrocoat material on the metallic substrate and curing said applied material at a temperature of 100 to 250° C., preferably 140 to 220° C. for a period of 5 to 60 minutes, preferably 10 to 45 minutes. Before curing, said material can be flashed off, for example, at 15 to 35° C. for a period of, for example, 0.5 to 30 minutes and/or intermediately dried at a temperature of preferably 40 to 90° C. for a period of, for example, 1 to 60 minutes. Suitable electrocoat materials and also their curing are described in WO 2017/088988 A1, and comprise hydroxy-functional polyether amines as binder and blocked polyisocyanates as crosslinking agent. Before application of the electrocoating material, a conversion coating, such as a zinc phosphate coat, can be applied to the metallic substrate. The film thickness of the cured electrocoat is, for example, 10 to 40 micrometers, preferably 15 to 25 micrometers.

Metallic substrates comprising a cured electrocoating and/or a cured filler can be obtained by applying a filler composition to a metallic substrate (S) optionally comprising a cured electrocoating or to a metallic and/or plastic substrate (S) and curing said filler composition at a temperature of 40 to 100° C., preferably 60 to 80° C. for a period of 5 to 60 minutes, preferably 3 to 8 minutes. Suitable filler compositions are well known to the person skilled in the art and are, for example, commercially available under the brand name Glasurit from BASF Coatings GmbH. The film thickness of the cured filler is, for example, 30 to 100 micrometers, preferably 50 to 70 micrometers.

Optional Step (1):

In optional step (1) of the inventive method, at least one pigmented basecoat composition is applied on the substrate, a film is formed from said composition and said film is optionally cured. Preferably, the applied basecoat composition is only briefly dried before the inventive coating composition is afterwards applied in step (2). Joint curing of the basecoat film and the film formed from the inventive coating composition is then performed in optional step (4) of the inventive method. The application of a coating composition to the substrate is understood as follows: the coating composition in question is applied such that the coating film produced from said composition is disposed on the substrate, but need not necessarily be in direct contact with the substrate. For example, between the coating film and the substrate, there may be other coats disposed. Preferably, the coating composition is applied directly to the substrate in step (1), meaning that the coating film produced is in direct contact with the substrate.

The pigmented basecoat compositions may be applied by the methods known to the skilled person for applying liquid coating materials, as for example by dipping, knifecoating, spraying, rolling, or the like. Preference is given to employing spray application methods, such as, for example, compressed air spraying (pneumatic application), airless spraying, high-speed rotation, electrostatic spray application (ESTA), optionally in conjunction with hot spray application such as hot air (hot spraying), for example. With very particular preference the pigmented basecoat composition is applied via pneumatic spray application or electrostatic spray application. The pigmented basecoat composition is applied such that the basecoat layer preferably has a film thickness of 5 to 35 μm, preferably 10 to 30 μm.

After application, the basecoat composition can be flashed off and/or dried in order to form a basecoat film on the substrate. “Flashing” or “flash off” is understood as passive or active evaporation of solvents from the pigmented basecoat composition, preferably at 15 to 35° C. for a duration of 0.5 to 30 minutes. In contrast, drying is understood as passive or active evaporation of solvents at a higher temperature than used for flashing, for example at 40 to 90° C. for a duration of 1 to 60 minutes. However, neither flash off nor drying does result in a cured coating layer.

Curing of the basecoat film formed after flash off and/or drying is preferably performed at temperatures of 50 to 200° C., preferably 120 to 160° C., for a duration of 20 to 40 minutes. The curing of a coating film or composition is understood accordingly to be the conversion of such a film or composition into the service-ready state, in other words into a state in which the substrate furnished with the coating film in question can be transported, stored, and used in its intended manner. A cured coating film, then, is in particular no longer soft, but instead is conditioned as a solid coating film which, even on further exposure to curing conditions as described later on below, no longer exhibits any substantial change in its properties such as hardness or adhesion to the substrate.

However, it is preferred within the present invention if the basecoat film is not cured separately but jointly with the subsequently applied coating composition of the invention.

Suitable basecoat compositions are all aqueous and solvent-borne pigmented basecoat compositions known to the person skilled in the art. Preferably, aqueous pigmented basecoat compositions are used.

It is possible in step (1) to apply more than one basecoat film or basecoat layer by repeating step (1). The basecoat compositions used if step (1) is repeated can be the same or can differ from each other. For example, the first basecoat composition can contain only color pigments while the second basecoat composition can contain only effect pigments.

Step (2):

In step (2) of the inventive method, an inventive coating composition is applied to the basecoat film or cured basecoat layer formed in optional step (1) or to the substrate. The inventive coating compositions may be applied by the methods known to the skilled person for applying liquid coating materials, as for example by dipping, knifecoating, spraying, rolling, or the like. With very particular preference the coating composition is applied via pneumatic spray application or electrostatic spray application.

Step (3):

In step (3) of the inventive method, a coating film is formed from the coating composition applied in step (2). The formation of a film from the applied coating composition can be effected, for example, by flashing off and/or drying the applied coating composition as previously described in connection with optional step (1).

The formation of the coating film in step (3) is performed at a temperature of 20 to 60° C. for a duration of 5 to 40 minutes, preferably performed at a temperature of 20 to 35° C. for a duration of 5 minutes to 15 minutes.

Step (4):

In step (4) of the inventive method, the coating film produced in step (1) and/or (3) is cured. In case optional step (1) is performed and the basecoat film resulting from step (1) has not yet been cured, curing of said at least basecoat layer is done together with the curing of the coating film formed in step (3).

In principle the curing is carried out at temperatures of 40 to 200° C., for example, in particular 120 to 160° C., for a duration of 5 to 80 minutes, preferably 20 to 40 minutes.

Typically layer thicknesses obtained after step (4) range from 15 μm to 80 μm, preferably 20 μm to 70 μm or 30 μm to 65 μm such as 40 μm to 60 μm.

The coating layers produced from the inventive coating compositions have an improved resistance towards scratches and show a higher flexibility compared to coating layers produced from acrylic resins. However, the optical properties are not negatively influenced, i.e. the coating layers produced by the inventive coating compositions have a high gloss, are non-yellowing and can be produced in thick layers of more than 40 μm without cracking. Due to their high flexibility, said coating layers are especially suitable for the coating of flexible plastic parts or parts comprising metallic and plastic components.

What has been said about the inventive coating composition applies mutatis mutandis with respect to further preferred embodiments of the inventive method.

Inventive Use:

Finally, the present invention relates to the use of the inventive coating composition for improving the elongation and scratch resistance of coating layers, especially of clearcoat layers, wherein said improvement is obtained with respect to a coating composition not containing a binder B comprising the ethylene copolymer.

What has been said about the inventive coating composition and the inventive method applies mutatis mutandis with respect to further preferred embodiments of the inventive use.

The invention is described in particular by the following embodiments:

Embodiment 1: coating composition comprising:
a) at least one binder B containing an ethylene copolymer, said ethylene copolymer comprising—in polymerized form and based on the total weight of the ethylene copolymer—
   i. 10 to 80 wt. % of ethylene;
   ii. 1 to 90 wt. % of at least one polymerizable compound C1 having at least one hydroxyl group and/or 1 to 80 wt. % of at least one polymerizable compound C2 having at least one epoxide group; and
   iii. 0 to 80 wt. % of at least one further polymerizable compound C3 different from compounds C1 and C2; and
b) at least one crosslinking agent CA comprising at least one reactive functional group which is able to undergo crosslinking reactions with complementary reactive functional groups present in the at least one binder B.

Embodiment 2: coating composition according to embodiment 1, wherein the ethylene copolymer is prepared in a continuous high-pressure polymerization process.

Embodiment 3: coating composition according to embodiment 2, wherein the polymerization process is carried out at a pressure in the range from 1,000 to 4,000 bar, preferably from 1,200 to 2,500 bar, very preferably 1,500 to 2,200 bar.

Embodiment 4: coating composition according to embodiment 2 or 3, wherein the reaction temperature is in the range of 150 to 300° C., preferably 170 to 250° C., and in particular 190 to 230° C.

Embodiment 5: coating composition according to any of embodiments 2 to 4, wherein the polymerization process is carried out using a monomer feed comprising ethylene, the at least one polymerizable compound C1 and/or C2 and optionally the at least polymerizable compound C3.

Embodiment 6: coating composition according to embodiment 5, wherein the monomer feed comprises ethylene in a total amount of 30 to 95 wt. %, preferably 40 to 90 wt. %, and in particular 50 to 70 wt. % or from 70 to 85 wt. %, based on the total weight of the monomer feed.

Embodiment 7: coating composition according to embodiment 5 or 6, wherein the monomer feed comprises the at least one polymerizable compound C1 comprising at least one hydroxy group in a total amount of 5 to 70 wt. %, preferably 8 to 60 wt. %, and in particular 36 to 55 wt. % or 12 to 35% wt., based in each case on the total weight of the monomer feed.

Embodiment 8: coating composition according to any of embodiments 5 to 7, wherein the monomer feed comprises the at least one polymerizable compound C2 comprising at least one epoxy group in a total amount of 5 to 70 wt. %, preferably 8 to 60 wt. %, and in particular 36 to 55 wt. % or 12 to 35% wt., based in each case on the total weight of the monomer feed.

Embodiment 9 coating composition according to any of embodiments 5 to 8, wherein the monomer feed comprises the at least one polymerizable compound C3 in a total amount of 5 to 70 wt. %, preferably 10 to 60 wt. %, and in particular 15 to 55 wt. %, based in each case on the total weight of the monomer feed.

Embodiment 10: coating composition according to any of embodiments 2 to 9, wherein the polymerization process is carried out in the presence of at least one chain transfer agent, said chain transfer agent being preferably selected from saturated or unsaturated hydrocarbons, aliphatic ketones, aliphatic aldehydes, hydrogen, or mixtures thereof, more preferably aliphatic aldehydes and/or aliphatic ketones and/or hydrogen, very preferably propionaldehyde and/or methyl ethyl ketone and/or hydrogen.

Embodiment 11: coating composition according to embodiment 10, wherein the chain transfer agent is a mixture of propionaldehyde and methyl ethyl ketone in a weight ratio of 4:1 to 1:4, preferably from 3.5:1 to 1:3.0, in particular from 2.8:1 to 1:2.5.

Embodiment 12: coating composition according to embodiment 10 or 11, wherein the at least one chain transfer agent is present in a total amount of least 2 wt. %, preferably 4 to 28 wt. %, more preferably 6 to 23 wt. %, very preferably 9 to 13 wt. % or 13 to 20 wt. %, based on the total weight of the monomer feed.

Embodiment 13: coating composition according to any of embodiments 2 to 12, wherein the polymerization process is carried out in the presence of at least one initiator, said initiator being preferably selected from di-tert-butyl peroxide, tert-amyl peroxypivalate, tert-butyl peroxypivalate, tert-butyl peroxyisononanoate, tert-butyl peroxy-2-ethylhexanoate, 2,2-di(tert-butylperoxy)butane and mixtures thereof, very preferably from tert-amyl peroxypivalate.

Embodiment 14: coating composition according to embodiment 13, wherein the initiator is present in a total amount of 0.001 to 0.1 wt. %, preferably 0.01 to 0.05 wt. % based in each case on the total weight of the monomer feed.

Embodiment 15: coating composition according to any of embodiments 2 to 14, wherein the polymerization process is followed by a hydrogenation.

Embodiment 16: coating composition according to any of the preceding embodiments, wherein the ethylene copolymer has a pour point below 25° C., preferably below 20° C., and in particular below 15° C., as determined according to ASTM D 97-05.

Embodiment 17: coating composition according to any of the preceding embodiments, wherein the ethylene copolymer has a hydroxyl number from 50 to 250 mg KOH/g solids, preferably from 50 to 200 mg KOH/g solids, very preferably 100 to 200 mg KOH/g solids, as determined according to JIS K 0070:1992.

Embodiment 18: coating composition according to any of the preceding embodiments, wherein the ethylene copolymer has a weight-average molecular weight M, from 1,000 to 30,000 g/mol, preferably from 1,500 to 15,000 g/mol, very preferably 3,000 to 10,000 g/mol, as determined by gel-permeation chromatography using polystyrene standards.

Embodiment 19: coating composition according to any of the preceding embodiments, wherein the ethylene copolymer has a polydispersity PD (M_{w}/Mₙ) of 1.5 to 3, preferably 1.7 to 2.5.

Embodiment 20: coating composition according to any of the preceding embodiments, wherein the ethylene copolymer has a kinematic viscosity at 120° C. (V120) of 10 to 6,000 mm²/s, preferably 40 to 4,000 mm²/g, very preferably 70 to 2,300 mm²/g, as determined according to ASTM D 445-2018.

Embodiment 21: coating composition according to any of the preceding embodiments, wherein the ethylene copolymer comprises—in polymerized form and based in each case on the total weight of the ethylene copolymer—from 20 to 70 wt. %, preferably from 25 to 65 wt. %, more preferably from 30 to 60 wt. %, of ethylene, as determined by ¹H-NMR.

Embodiment 22: coating composition according to any of the preceding embodiments, wherein the at least one polymerizable compound C1 comprising at least one hydroxyl group is selected from hydroxyl group-containing (meth)acrylates, preferably hydroxy C₁-C₁₂ alkyl group-containing (meth)acrylates, more preferably selected from 2-hydroxyethyl (meth)acrylate, 2-hydroxyisopropyl (meth)acrylate, 3-hydroxypropyl (meth)acrylate, hydroxyisobutyl (meth)acrylate and 4-hydroxybutyl (meth)acrylate, very preferably 2-hydroxyethyl (meth)acrylate.

Embodiment 23: coating composition according to any of the preceding embodiments, wherein the ethylene copolymer comprises—in polymerized form and based in each case on the total weight of the ethylene copolymer—from 1 to 70 wt. %, preferably from 3 to 60 wt. %, more preferably from 7 to 50 wt. %, of at least one polymerizable compound C1 comprising at least one hydroxyl group, preferably 2-hydroxyethyl (meth)acrylate, as determined by ¹H-NMR.

Embodiment 24: coating composition according to any of the preceding embodiments, wherein the at least one polymerizable compound C2 comprising at least one epoxide group is selected from glycidyl acrylate and/or glycidyl methacrylate.

Embodiment 25: coating composition according to any of the preceding embodiments, wherein the ethylene copolymer comprises—in polymerized form and based in each case on the total weight of the ethylene copolymer—from 5 to 70 wt. %, preferably from 10 to 60 wt. %, more preferably from 15 to 55 wt. %, of at least one polymerizable compound C2 comprising at least one epoxide group, preferably glycidyl acrylate and/or glycidyl methacrylate, as determined by ¹H-NMR.

Embodiment 26: coating composition according to any of the preceding embodiments, wherein the at least one polymerizable compound C3 is selected from alkyl (meth)acrylates, preferably C₁-C₂₂ alkyl (meth)acrylates, more preferably C₁-C₁₂ alkyl (meth)acrylates, very preferably methyl (meth)acrylate and/or n-butyl (meth)acrylate and/or 2-ethylhexyl (meth)acrylate.

Embodiment 27: coating composition according to any of the preceding embodiments, wherein the ethylene copolymer comprises—in polymerized form and based in each case on the total weight of the ethylene copolymer—from 5 to 75 wt. %, preferably from 10 to 70 wt. %, more preferably from 15 to 60 wt. %, of at least one polymerizable compound C3, preferably methyl (meth)acrylate and/or n-butyl (meth)acrylate and/or 2-ethylhexyl (meth)acrylate, as determined by ¹H-NMR.

Embodiment 28: coating composition according to any of the preceding embodiments, wherein the at least one binder B comprises
at least one binder B-1 containing an ethylene copolymer, said ethylene copolymer comprising—in polymerized form and based in each case on the total weight of the ethylene copolymer—10 to 80 wt. % of ethylene, 1 to 90 wt. % of at least one polymerizable compound C1 having at least one hydroxyl group and 0 to 80 wt. % of at least one further polymerizable compound C3 different from compound C1; and
at least one binder B-2 containing an ethylene copolymer, said ethylene copolymer comprising—in polymerized form and based in each case on the total weight of the ethylene copolymer—10 to 80 wt. % of ethylene, 1 to 80 wt. % of at least one polymerizable compound C2 having at least one epoxide group and 0 to 80 wt. % of at least one further polymerizable compound C3 different from compound C2.

Embodiment 29: coating composition according to any of the preceding embodiments, wherein the coating composition comprises the at least one binder B in a total amount of 10 to 60 wt. %, preferably 15 to 50 wt. %, more preferably 25 to 45 wt. %, very preferably 30 to 40 wt. %, based in each case on the total weight of the coating composition.

Embodiment 30: coating composition according to any of the preceding embodiments, wherein the at least one crosslinking agent CA is selected from blocked and/or unblocked polyisocyanates, melamine resins, polycarbodiimides, triazines, preferably trialkoxycarbamatotriazine, polyfunctional acid resins and mixtures thereof, preferably blocked and/or unblocked polyisocyanates.

Embodiment 31: coating composition according to any of the preceding claims, wherein the composition comprises an equivalent value of all reactive functional groups present in the at least one crosslinking agent (CA) to all complementary reactive functional groups present in the at least one binder B of 0.5 to 2.0, preferably 0.5 to 1.5, more preferably 0.8 to 1.2.

Embodiment 32: coating composition according to any of the preceding embodiments, wherein the at least one crosslinking agent CA is present in a total amount of 4 to 40 wt. %, preferably 5 to 35 wt. %, more preferably 10 to 30 wt. %, very preferably 12 to 25 wt. %, based in each case on the total weight of the coating composition.

Embodiment 33: coating composition according to any of the preceding embodiments, wherein the coating composition further comprises at least one crosslinking catalyst CAT.

Embodiment 34: coating composition according to embodiment 33, wherein the at least one crosslinking catalyst CAT is selected from tin containing catalysts, bismuth containing catalysts, zirconium containing catalysts, lithium containing catalysts and mixtures thereof, preferably dibutyltin dilaurate, bismuth carboxylates, zirconium carboxylates, lithium carboxylates and mixtures thereof.

Embodiment 35: coating composition according to embodiment 33 or 34, wherein the at least one crosslinking catalyst CAT, preferably dibutyltin dilaurate, bismuth carboxylates, zirconium carboxylates, lithium carboxylates and mixtures thereof, is present in a total amount of 0.005 to 1 wt. %, preferably 0.08 to 0.2 wt. %, based in each case on the total weight of the coating composition.

Embodiment 36: coating composition according to any of the preceding embodiments, wherein the coating composition further comprises at least one binder B1, said binder B1 being different from binder B.

Embodiment 37: coating composition according to any of the preceding embodiments, wherein the coating composition further comprises at least one additive selected from the group consisting of (i) UV absorbers; (ii) light stabilizers such as HALS compounds, benzotriazoles or oxalanilides; (iii) rheology modifiers such as sagging control agents (urea crystal modified resins), organic thickeners and inorganic thickeners; (iv) free-radical scavengers; (v) slip additives; (vi) polymerization inhibitors; (vii) defoamers; (viii) wetting agents; (ix) fluorine compounds; (x) adhesion promoters; (xi) leveling agents; (xii) film-forming auxiliaries such as cellulose derivatives; (xiii) fillers, such as nanoparticles based on silica, alumina or zirconium oxide; (xiv) flame retardants; and (xv) mixtures thereof.

Embodiment 38: coating composition according to any of the preceding embodiments, wherein it is a one-component or a two-component coating composition.

Embodiment 39: coating composition according to any of the preceding embodiments, wherein it is a clearcoat composition or a tinted clearcoat composition.

Embodiment 40: coating composition according any of the preceding embodiments, wherein the coating composition comprises 0 to 20 wt. %, preferably 0 to 10 wt. %, more preferably 0 to 5 wt. %, and very preferably 1 to 5 wt. % of water, based in each case on the total weight of the coating composition.

Embodiment 41: coating composition according any of the preceding embodiments, wherein the coating composition has a solids content of 40 to 60% by weight, preferably 50% by weight, based in each case on the total weight of the coating composition.

Embodiment 42: a method for producing at least one coating on a substrate, comprising
(1) optionally applying a pigmented basecoat composition to the substrate, forming a coating film from said basecoat composition and optionally curing said basecoat film;
(2) applying a coating composition as claimed in any of embodiments 1 to 41 to the substrate or the coated substrate obtained after step (1);
(3) forming a coating film from the composition applied in step (2); and
(4) curing the coating film(s) obtained after step (1) and/or (3).

Embodiment 43: method according to embodiment 42, where said method is used for producing at least one coating layer, more particularly a clearcoat coating layer, for automotive OEM finishing and/or for the finishing of parts for installation in or on automobiles and/or for the finishing of commercial vehicles and/or for automotive refinishing.

Embodiment 44: method according to embodiment 42 or 43, characterized in that the substrate is selected from metallic substrates, metallic substrates coated with a cured electrocoat and/or a cured filler, plastic substrates and substrates comprising metallic and plastic components, preferably from metallic substrates.

Embodiment 45: method according to embodiment 44, characterized in that the metallic substrate is selected from the group comprising or consisting of iron, aluminum, copper, zinc, magnesium and alloys thereof as well as steel.

Embodiment 46: a coating obtained by a method as claimed in any of embodiments 42 to 45.

Embodiment 47: use of a coating composition as claimed in any of embodiments 1 to 41 for improving the elongation and scratch resistance of coating layers, especially of clear coating layers.

### EXAMPLES

The present invention will now be explained in greater detail through the use of working examples, but the present invention is in no way limited to these working examples. Moreover, the terms “parts”, “%” and “ratio” in the examples denote “parts by mass”, “mass %” and “mass ratio” respectively unless otherwise indicated.

1. Methods of Determination:

1.1 Number-average Molecular Weight (Mₙ), Weight-average Molecular Weight (M_{w}), and Polydispersity Index (PDI)

The number-average molecular weight distribution (Mₙ) and the weight-average molecular weight distribution (M_{w}) were, unless otherwise indicated, determined via GPC. The polydispersity (PDI) was calculated as PDI=(M_{w}/Mₙ). The GPC analysis was made with a RI (refraction index) detector, column temperature 35° C. and THF with 0,1% trifluoro acetic acid as elution medium. The calibration was done with very narrow distributed polystyrene standards from the Polymer Laboratories with a molecular weight M_{w}=from 580 until 6.870.000 g/mol.

1.2 Amount of Ethylene and Compounds C1 to C3 Present in Polymerized Form in the Ethylene Copolymer

The amount of ethylene as well as polymerizable compounds C1 and/or C2 and optionally C3 present in polymerized form in the ethylene copolymer is determined by ¹H-NMR, a method know to the skilled person.

1.3 Kinematic Viscosity

The kinematic viscosity at 120° C. (V120) was determined according to ASTM D 445-2018.

1.4 Pour Point (PP)

The Pour Point PP was determined according to ASTM D 97-05.

1.5 Solid Content (Solids, Non-volatile Fraction)

Unless otherwise indicated, the solids content, also referred to as solid fraction or non-volatile fraction hereinafter, was determined in accordance with DIN EN ISO 3251-2008-06 at 130° C.; 60 min, initial mass 1.0 g.

1.6 Hydroxyl Number (OH Number)

The hydroxyl number was determined according to JIS K 0070:1992.

1.7 Glass Transition Temperature (T_{g})

The glass transition temperature (T_{g}) of the polymers was determined with DMA (dynamic mechanical analysis). The T_{g} of the cured polymer film is corresponding to the temperature of the highest tan δ, which is measured at a frequency of 110 Hz and a temperature increase of 2° C. per minute using a forced stretching vibration type viscoelasticity measuring device (produced by A&D Company, limited; trade name “RHEOVIBRON DDV-01 GP”).

1.8 Cloud Point (CP)

The cloud point was determined according to DIN EN ISO 3015:2018-04.

2. Synthesis of Different Binders

Abbreviations of Components

E: ethylene

NBA: N-butyl acrylate

MMA: Methyl methacrylate

HEMA: Hydroxyethyl methacrylate

PA: Propionaldehyde

MEK: Methylethylketone

2.1 Synthesis of Ethylene Copolymers B-I1 and B-I2

A high-pressure autoclave of the type described in the literature (M. Buback et al., Chem. Ing. 25 Tech. 1994, 66, 510-513) was used for continuous copolymerization.

Ethylene was fed continuously into a first compressor until approximately 250 bar were reached. Separately from this, the respective amount of HEMA and alkyl (meth)acrylate (NBA or MMA) was also compressed continuously to an intermediate pressure of 250 bar and was mixed with the ethylene feed. The ethylene/acrylate mixture was further compressed using a second compressor. The reaction mixture is fed to a 1-liter autoclave having the pressure and temperature listed in Table 1. The desired temperature is maintained by the adjusting the amount of initiator tert-amyl peroxypivalate in isodecane, which is introduced to the autoclave separately from the monomer feed (about 1,000 to 1,500 ml/h).

Separately from this, the amount of chain transfer agent (cf. Table 1 “Regulator Feed”) was first compressed to an intermediate pressure of 250 bar and then compressed with the aid of a further compressor to the reaction pressure before it was fed continuously into the high-pressure autoclave.

The output of each polymerization reaction listed in Table 1 was usually around 5 to 6 kg/h at a conversion of 30 to 45 wt. % (based on ethylene feed). Details of the reaction conditions are summarized in Table 1. The analytical data of the prepared ethylene copolymers is summarized in Table 2.

TABLE 1
Reaction conditions

| Ethylene | | | | Ethylene | Acrylate | Regulator |
|---|---|---|---|---|---|---|
| copolymer | Reactants | P [bar] | T [° C.] | feed [g/h] | feed [g/h] | feed [g/h] |
| B-I1 | E, HEMA, MMA | 1796 | 202 | 12015 | HEMA: 1685 | PA: 1200 (6.5 wt. %) |
| | | | | | MMA: 1695 | MEK: 1685 (9.21 wt. %) |
| B-I2 | E, HEMA, NBA | 1802 | 203 | 12000 | HEMA: 1755 | PA: 1200 (6.4 wt. %) |
| | | | | | NBA: 1770 | MEK: 1755 (9.4 wt. %) |

TABLE 2
Analytical data of obtained ethylene copolymers B-I1 and B-I2

| | | Ethylene copolymer | |
|---|---|---|---|
| | | B-I1 | B-I2 |
| Monomer | Ethylene | 38.0 | 34.0 |
| composition | 2-hydroxy ethyl methacrylate | 29.0 | 36.0 |
| (wt. %) | Methyl methacrylate | 33.0 | 0 |
| | n-Butyl acrylate | 0 | 30.0 |
| | Total | 100 | 100 |

| | | |
|---|---|---|
| Number-average molecular weight (Mₙ) [g/mol] | 2780 | 3129 |
| Weight-average molecular weight (M_{w}) [g/mol] | 6190 | 7020 |
| Polydispersity (PD) | 2, 2 | 2, 3 |
| Kinematic viscosity at 120° C. (V120) [mm²/s] | 1130 | 400 |
| Hydroxyl number [mg KOH/g] | 125 | 155 |
| Glass transition temperature (T_{g}) [° C.] | −41.8 | −63.1 |
| Non-volatile content (%) | 100 | 100 |

The ethylene copolymers B-I1 and B-I2 each have a pour point (PP) below 25° C. and thus can be easily incorporated into coating compositions being liquid at room temperature (i.e. 20 to 25° C.).

2.2 Synthesis of Comparative Acrylic Resins B-C1 and B-C2

22.5 part of propylene glycol monomethoxy ether acetate and 7.5 part of methyl amyl ketone were placed in a 4-neck flask fitted with a thermometer, reflux condenser, stirrer and dropping funnel, and this mixture was heated with stirring under a nitrogen flow to a temperature of 140° C. Next, at a temperature of 140° C., the respective amounts of HEMA and EHA or NBA listed in Table 3 along with 3.0 parts of t-butyl peroxy-2-ethylhexanoate as polymerization initiator were homogeneously mixed and added dropwise from the dropping funnel at a constant rate over 3 hours. After completion of the dropwise addition, the temperature was maintained at 140° C. for 1 hour, then the reaction temperature was lowered to 110° C. Then, as supplementary catalyst, 0.1 parts of t-butyl peroxy-2-ethylhexanoate were added as polymerization initiator, and the temperature was maintained at 110° C. for another 2 hours. Then, the reaction mixture was diluted and cooled by adding 8.9 parts of propylene glycol monomethoxy ether acetate.

TABLE 3
Amounts of HEMA and EHA used to prepare acrylic
resins B-C1 and B-C2 (amounts in % by weight)

Acrylic resin

| Monomers | B-C1 | B-C2 |
|---|---|---|
| HEMA | 17.38 | 21.60 |
| EHA | 42.62 | 20.40 |
| NBA | 0 | 18.00 |
| Total | 100 | 100 |

The properties of the obtained comparative acrylic resins B-C1 and B-C2 are listed in Table 4:

| | Acrylic resin | |
|---|---|---|
| | B-C1 | B-C2 |
| Hydroxyl number [mg KOH/g] | 125 | 155 |
| Glass transition temperature (T_{g}) [° C.] | −27 | −23 |
| Non-volatile content (%) | 60 | 60 |
| Weight-average molecular weight (M_{w}) [g/mol] | 6,500 | 6,500 |

3. Preparation of Coating Compositions

The clearcoat compositions listed in Tables 5-1 and 5-2 were prepared by mixing the ingredients listed under “base varnish (A)” until a homogenous mixture is obtained. To this mixture, the pre-mixed ingredients listed under “hardener (B)” were added and the mixture was stirred until a homogenous clearcoat composition is obtained.

TABLE 5-1
Preparation of inventive clearcoat compositions CC-I1 to CC-I5 and comparative clearcoat compositions CC-C1 to CC-C5

| | | Inventive examples | | | | | Comparative examples | | | | |
|---|---|---|---|---|---|---|---|---|---|---|---|
| | | CC-I1 | CC-I2 | CC-I3 | CC-I4 | CC-I5 | CC-C1 | CC-C2 | CC-C3 | CC-C4 | CC-C5 |
| Base varnish (A) | Ethylene copolymer B-I1 | 35.0 | 35.0 | 35.0 | 35.0 | 35.0 | 0 | 0 | 0 | 0 | 0 |
| | Acrylic resin B-C1 | 0 | 0 | 0 | 0 | 0 | 58.3 | 58.3 | 58.3 | 58.3 | 58.3 |
| | DBTDL, 1% solution¹⁾ | 1.0 | 1.0 | 1.0 | 1.0 | 1.0 | 1.0 | 1.0 | 1.0 | 1.0 | 1.0 |
| | Tinuvin 384-2²⁾ | 1.0 | 1.0 | 1.0 | 1.0 | 1.0 | 1.0 | 1.0 | 1.0 | 1.0 | 1.0 |
| | Tinuvin 292³⁾ | 1.0 | 1.0 | 1.0 | 1.0 | 1.0 | 1.0 | 1.0 | 1.0 | 1.0 | 1.0 |
| | BYK-325⁴⁾ | 0.2 | 0.2 | 0.2 | 0.2 | 0.2 | 0.2 | 0.2 | 0.2 | 0.2 | 0.2 |
| | Xylene | 37.6 | 34.3 | 31.0 | 27.6 | 24.3 | 24.3 | 21.0 | 17.6 | 14.3 | 10.9 |
| | Cyclohexanone | 10.0 | 10.0 | 10.0 | 10.0 | 10.0 | 0 | 0 | 0 | 0 | 0 |
| Hardener (B) | Duranate TPA-100⁵⁾ | 14.2 | 10.6 | 7.1 | 3.5 | 0 | 14.2 | 10.6 | 7.1 | 3.5 | 0 |
| | Desmodur Z4470SN⁶⁾ | 0 | 6.9 | 13.8 | 20.6 | 27.5 | 0 | 6.9 | 13.8 | 20.6 | 27.5 |

| | | | | | | | | | | |
|---|---|---|---|---|---|---|---|---|---|---|
| Total | 100 | 100 | 100 | 100 | 100 | 100 | 100 | 100 | 100 | 100 |
| Mol ratio NCO/OH | 1.0 | 1.0 | 1.0 | 1.0 | 1.0 | 1.0 | 1.0 | 1.0 | 1.0 | 1.0 |
| Molecular ratio HDI/IPDI | 100/0 | 75/25 | 50/50 | 25/75 | 0/100 | 100/0 | 75/25 | 50/50 | 25/75 | 0/100 |

¹⁾DBTDL 1% solution: catalyst; solution of Dibutyltin Dilaurate 1% and Xylene 99%
²⁾Tinuvin 384-2: brand name, BASF Japan (Co.), benzo-triazole UV absorber (non-volatiles content 95 mass %)
³⁾Tinuvin 292: brand name, BASF Japan (Co.), photo-stabilizer
⁴⁾BYK-325: brand name, Byk Chemie (Co.), silicone surface modifier (non-volatiles content 52 mass %)
⁵⁾Duranate TPA-100: brand name, Asahi Kasei (Co.), HDI isocyanate resin (non-volatiles content 100 mass %, NCO % content 23.1 mass %)
⁶⁾Desmodur Z4470SN: brand name, Covestro Japan Ltd. IPDI isocyanate resin (non-volatiles content 70 mass %, NCO % content 11.9 mass %)

TABLE 5-2
Preparation of inventive clearcoat compositions CC-I6 to CC-I9
and comparative clearcoat compositions CC-C6 to CC-C9

| | | Inventive examples | | | | Comparative examples | | | |
|---|---|---|---|---|---|---|---|---|---|
| | | CC-I6 | CC-I7 | CC-I8 | CC-I9 | CC-C6 | CC-C7 | CC-C8 | CC-C9 |
| Base varnish (A) | Ethylene copolymer B-I2 | 35.0 | 35.0 | 35.0 | 35.0 | 0 | 0 | 0 | 0 |
| | Acrylic resin B-C2 | 0 | 0 | 0 | 0 | 58.3 | 58.3 | 58.3 | 58.3 |
| | DBTDL, 1% solution¹⁾ | 1.0 | 1.0 | 1.0 | 1.0 | 1.0 | 1.0 | 1.0 | 1.0 |
| | Tinuvin 384-2²⁾ | 1.0 | 1.0 | 1.0 | 1.0 | 1.0 | 1.0 | 1.0 | 1.0 |
| | Tinuvin 292³⁾ | 1.0 | 1.0 | 1.0 | 1.0 | 1.0 | 1.0 | 1.0 | 1.0 |
| | BYK-325⁴⁾ | 0.2 | 0.2 | 0.2 | 0.2 | 0.2 | 0.2 | 0.2 | 0.2 |
| | Xylene | 29.3 | 25.1 | 21.8 | 17.7 | 20.9 | 16.8 | 13.4 | 10.1 |
| | Cyclohexanone | 10.0 | 10.0 | 10.0 | 10.0 | 0 | 0 | 0 | 0 |
| Hardener (B) | Duranate TPA-100⁵⁾ | 12.3 | 7.9 | 4.4 | 0 | 17.6 | 13.2 | 9.7 | 6.2 |
| | Desmodur Z4470SN⁶⁾ | 10.2 | 18.8 | 25.6 | 34.1 | 0 | 8.5 | 15.4 | 22.2 |

| | | | | | | | | |
|---|---|---|---|---|---|---|---|---|
| Total | 100 | 100 | 100 | 100 | 100 | 100 | 100 | 100 |
| Mol ratio NCO/OH | 1.0 | 1.0 | 1.0 | 1.0 | 1.0 | 1.0 | 1.0 | 1.0 |
| Molecular ratio HDI/IPDI | 70/30 | 45/55 | 25/75 | 0/100 | 100/0 | 75/25 | 55/45 | 35/65 |

¹⁾DBTDL 1% solution: catalyst; solution of Dibutyltin Dilaurate 1% and Xylene 99%
²⁾Tinuvin 384-2: brand name, BASF Japan (Co.), benzo-triazole UV absorber (non-volatiles content 95 mass %)
³⁾Tinuvin 292: brand name, BASF Japan (Co.), photo-stabilizer
⁴⁾BYK-325: brand name, Byk Chemie (Co.), silicone surface modifier (non-volatiles content 52 mass %)
⁵⁾Duranate TPA-100: brand name, Asahi Kasei (Co.), HDI isocyanate resin (non-volatiles content 100 mass %, NCO % content 23.1 mass %)
⁶⁾Desmodur Z4470SN: brand name, Covestro Japan Ltd. IPDI isocyanate resin (non-volatiles content 70 mass %, NCO % content 11.9 mass %)

4. Evaluation of Physical Properties of Coating Films

4.1 Preparation of Coating Films

Coating films are obtained from the coating compositions CC-I1 to CC-I9 (inventive) and CC-C1 to CC-C9 (comparative) by application on a polypropylene-made plate (substrate) by means of air spray in the manner such that the dry film thickness was 35 μm. Heating was applied at 140° C. for 30 minutes, after which the coating film was peeled by hand from the polypropylene-made plate to provide respective coating films.

4.1 Dynamic Viscoelasticity Measurement

A test piece of the coating film as prepared above is cut into a piece having a size of 5 mm×20 mm and is used for measurement by means of a dynamic viscoelasticity measuring device. As the dynamic viscoelasticity measuring device, an automatic dynamic viscoelastometer (manufactured by A&D Company, Limited.) is used, and tan δ is determined from a phase difference generated between the vibration strain and the stress generated at the time of elevating a temperature. Glass transition temperature is obtained at the temperature when tan δ reaches the maximum value. Herein, the measurement frequency is 11 Hz, and the temperature increase rate is 2° C/minute.

4.2 Tensile Property

Another test piece of the coating film prepared in the same manner as above was cut into a piece having a size of 10 mm×70 mm. The sample was subjected to a measurement by means of a tensile strength measuring device (Autograph AG-IS, manufactured by Shimadzu Corporation). The tensile strength measurement was performed at a temperature of 20° C., a pulling rate of 4 mm/min and with a measurement length of 40 mm, while the load applied at the time of breaking is recorded. The young's modulus, elongation % at braking point, film tensile strength and breaking energy were recorded.

5. Preparation of Coated Substrates and Evaluation of Clearcoat Layer

5.1 Preparation of Coated Substrates

Zinc-plated steel plates (0.8 mm thick, 150 mm long and 70 mm) wide were chemically treated with zinc phosphate, electrocoated using the cationic electrocoat paint Cathoguard® 500 (BASF Japan (Co.)) to give a dry film thickness of 25 μm, and baked for 30 minutes at 170° C. A primer coat HS-H300 Dark Gray (brand name, BASF Japan (Co.)) was spray applied to give a dry film thickness of 30 μm, and baked for 30 minutes at 140° C. Next, the polyurethane polyester-melamine resin aqueous basecoat paint Aqua BC-3 Black (brand name, BASF Japan (Co.)) was spray-coated to give a dry film thickness of 15 μm, and was dried for 5 minutes at 80° C. After cooling the test plates to room temperature, the base varnish (A) and hardener (B) of coating compositions CC-I1 to CC-I9 and CC-C1 to CC-C9 according Tables 5-1 and 5-2 were homogeneously mixed and applied wet-in-wet by spray-coating to the basecoat film to give a dry film thickness of 35 μm. After maintaining the panels for 10 minutes at room temperature the samples were baked for 30 minutes at 140° C. to obtain the substrates coated with a multilayer coating. Afterwards, the properties of each clearcoat layer were determined with the methods described hereinafter.

5.2 Evaluation of Clearcoat Layer

5.2.1 Wet Scratch Resistance:

The wet scratch resistance of the respective clearcoat layer was tested using a laboratory car wash system from AMTEC-Kistler in accordance with DIN EN ISO 20566:2013-06. The resistance was determined by measuring the residual gloss of the sample using a gloss-meter from Byk-Gardener after 10 cycles in the laboratory car wash system with subsequent wiping with a cotton pad soaked with isopropanol.

5.2.2 Dry Scratch Resistance:

Dry scratch resistance was carried out with a crock meter (Atlas CMS, ATLAS Electronic devices Co.). The initial gloss of the samples (20° was measured perpendicularly to the length of the panels (which will also be the scratching direction). Gloss was measured with gloss-meter (micro-tri-gloss, BYK-GARDENER). The abrasive paper (3M 281 Q WET/DRYTM PRODUCTIONTM Polish Paper Sheets/grains 9 μm ID 60-0600-0213-0, 3M Co.) was cut in squares of 5×5 cm. The abrasive paper was hold on the wiper pad with a circlips with a felt (14995600, ATLAS Electronic devices Co.) between the paper and wiper pad. With the crock meter, a 9,4±0,1 N force was applied on a 16 mm diameter friction shoe. Ten back and forth movement were performed with the crock meter, while correctly maintaining the panel on the device. Two new scratches were made on each of the panels. The panels were heated for 30 minutes at 80° C. After cooling to room temperature (23° C.), the final gloss was measured with the gloss-meter.

5.3 Results

The results obtained for the clearcoat films produced according to point 4.1 and the clearcoat layers produced according to point 5.1 are shown in Tables 6-1 and 6-2.

TABLE 6-1
Physical properties of clearcoat layers obtained from clearcoat compositions CC-I1 to CC-I5 and CC-C1 to CC-C5 (in the upper
half of this table, only the differences with regard to the ingredients of the inventive and comparative examples are listed)

| | Inventive examples | | | | | Comparative examples | | | | |
|---|---|---|---|---|---|---|---|---|---|---|
| | CC-I1 | CC-I2 | CC-I3 | CC-I4 | CC-I5 | CC-C1 | CC-C2 | CC-C3 | CC-C4 | CC-C5 |
| Ethylene copolymer B-I1 | 35.0 | 35.0 | 35.0 | 35.0 | 35.0 | 0 | 0 | 0 | 0 | 0 |
| Acrylic resin B-C1 | 0 | 0 | 0 | 0 | 0 | 58.3 | 58.3 | 58.3 | 58.3 | 58.3 |
| Xylene | 37.6 | 34.3 | 31.0 | 27.6 | 24.3 | 24.3 | 21.0 | 17.6 | 14.3 | 10.9 |
| Cyclohexanone | 10.0 | 10.0 | 10.0 | 10.0 | 10.0 | 0 | 0 | 0 | 0 | 0 |
| Mol ratio NCO/OH | 1.0 | 1.0 | 1.0 | 1.0 | 1.0 | 1.0 | 1.0 | 1.0 | 1.0 | 1.0 |
| Molecular ratio HDI/IPDI | 100/0 | 75/25 | 50/50 | 25/75 | 0/100 | 100/0 | 75/25 | 50/50 | 25/75 | 0/100 |
| Glass transition temperature (Tg) [° C.] | 44 | 54 | 70 | 84 | 100 | 38 | 52 | 68 | 88 | 108 |
| Young's modulus [MPa] | 204 | 1,090 | 1,522 | 1,659 | 1,676 | 26 | 188 | 619 | 827 | 940 |
| Elongation at break [%] | 92.5 | 42.2 | 6.4 | 6.9 | 5.7 | 54.4 | 45.6 | 19.0 | 10.9 | 2.3 |
| Tensile strength [MPa] | 25.5 | 31.0 | 44.8 | 52.0 | 54.5 | 9.7 | 15.3 | 19.4 | 28.5 | 18.8 |
| Breaking energy [J/m²] | 14.3 | 11.2 | 3.2 | 2.4 | 2.2 | 3.0 | 4.4 | 2.7 | 3.4 | 0.4 |
| Wet scratch resistance (gloss retention rate %) | 94.3 | 92.2 | 92.2 | 91.5 | 88.8 | 92.2 | 90.9 | 89.1 | 88.3 | 84.1 |
| Dry scratch resistance (gloss retention rate %) | 93.3 | 92.8 | 92.4 | 88.8 | 85.6 | 83.6 | 83.4 | 81.8 | 69.4 | 64.3 |

TABLE 6-2
Physical properties of clearcoat layers obtained from clearcoat compositions CC-I6
to CC-I9 and CC-C6 to CC-C9 (in the upper half of this table, only the differences
with regard to the ingredients of the inventive and comparative examples are listed)

| | Inventive examples | | | | Comparative examples | | | |
|---|---|---|---|---|---|---|---|---|
| | CC-I6 | CC-I7 | CC-I8 | CC-I9 | CC-C6 | CC-C7 | CC-C8 | CC-C9 |
| Ethylene copolymer B-I2 | 35.0 | 35.0 | 35.0 | 35.0 | 0 | 0 | 0 | 0 |
| Acrylic resin B-C2 | 0 | 0 | 0 | 0 | 58.3 | 58.3 | 58.3 | 58.3 |
| Xylene | 29.3 | 25.1 | 21.8 | 17.7 | 20.9 | 16.8 | 13.4 | 10.1 |
| Cyclohexanone | 10.0 | 10.0 | 10.0 | 10.0 | 0 | 0 | 0 | 0 |
| Mol ratio NCO/OH | 1.0 | 1.0 | 1.0 | 1.0 | 1.0 | 1.0 | 1.0 | 1.0 |
| Molecular ratio HDI/IPDI | 70/30 | 45/55 | 25/75 | 0/100 | 100/0 | 75/25 | 55/45 | 35/65 |
| Glass transition temperature (Tg) [° C.] | 48 | 67 | 84 | 98 | 52 | 68 | 86 | 100 |
| Young's modulus [MPa] | 131 | 599 | 970 | 1,283 | 235 | 784 | 1,008 | 1,194 |
| Elongation at break [%] | 70.0 | 47.6 | 12.5 | 9.2 | 31.4 | 6.3 | 3.4 | 2.2 |
| Tensile strength [MPa] | 16.3 | 21.7 | 31.5 | 43.0 | 13.4 | 25.3 | 28.4 | 24.8 |
| Breaking energy [J/m²] | 11.8 | 11.8 | 4.8 | 2.1 | 4.2 | 2.4 | 1. | 0.8 |
| Wet scratch resistance (gloss retention rate %) | 92.0 | 91.0 | 90.4 | 90.2 | 88.0 | 86.0 | 81.7 | 78.4 |
| Dry scratch resistance (gloss retention rate %) | 94.4 | 89.5 | 88.8 | 85.6 | 85.6 | 83.6 | 80.8 | 76.4 |

6. Discussion of Results

As known to the skilled person, lowering the glass transition temperature of the coating usually results in having an improved wet scratch resistance. In contrast to this knowledge, comparison of the coating layers obtained from inventive examples CC-I1 to CC-I5 with the coating layers obtained from comparative examples CC-C1 to CC-C5 demonstrates a dramatically improved wet scratch resistance is obtained even though the coating layers have nearly identical glass transition temperatures (T_{g}). Further comparison of the properties of the coatings layers obtained from inventive examples CC-I1 to CC-I5 with coating layers obtained from comparative examples CC-C1 to CC-C5 shows that the dry scratch resistance and the breaking energy could be improved as well. Despite the improvement in scratch resistance, the coating layers obtained from the inventive examples CC-I5 to CC-I5 have a significantly higher elongation at break and thus a higher flexibility than the coating layers obtained from the comparative examples CC-C5 to CC-C5.

In inventive examples CC-I6 to CC-I9, the ethylene copolymer B-I2 having a rather low glass transition temperature of −63° C. is used. To allow comparison of the coating layers obtained from inventive examples CC-I6 to CC-I9 with the coating layers obtained from comparative examples CC-C6 to CC-C9, the glass transition temperature of the clearcoat layer obtained from the inventive examples had to be adjusted to the glass transition temperatures of coating layers obtained from the comparative examples containing acrylic resin B-C2, because said acrylic resin B-C2 has a much higher glass transition temperature compared to ethylene copolymer B-I2. Matching of the glass transition temperature of the respective coating layers was performed by adjusting the ratio of HDI/IPDI in the hardener component.

Also, comparison of inventive examples CC-I6 to CC-I9 with comparative examples CC-C6 to CC-C9 demonstrates, that the wet scratch resistance could be dramatically improved, even though the coating layers have nearly identical glass transition temperatures (T_{g}). Moreover, the coating layers obtained from the inventive examples CC-I6 to CC-I9 have an improved dry scratch resistance and the breaking energy as compared to coating layers obtained from comparative examples CC-C6 to CC-C9. Despite the improvement in scratch resistance, the coating layers obtained from the inventive examples CC-I6 to CC-I9 have a significantly higher elongation at break and thus a higher flexibility than the coating layers obtained from the comparative examples CC-C6 to CC-C9.

1. A coating composition comprising:
a) at least one binder B containing an ethylene copolymer, said ethylene copolymer comprising—in polymerized form and based on a total weight of the ethylene copolymer—
i. 10 to 80 wt. % of ethylene;
ii. 1 to 90 wt. % of at least one polymerizable compound C1 comprising at least one hydroxyl group and/or 1 to 80 wt. % of at least one polymerizable compound C2 comprising at least one epoxide group; and
iii. 0 to 80 wt. % of at least one further polymerizable compound C3 different from compounds C1 and C2; and
b) at least one crosslinking agent CA comprising at least one reactive functional group which is able to undergo crosslinking reactions with complementary reactive functional groups present in the at least one binder B.

2. The coating composition according to claim 1, wherein the ethylene copolymer is prepared in a continuous high-pressure polymerization process.

3. The coating composition according to claim 1, wherein the ethylene copolymer comprises—in polymerized form and based on the total weight of the ethylene copolymer—from 20 to 70 wt. % of ethylene, as determined by ¹H-NMR.

4. The coating composition according to claim 1, wherein the at least one polymerizable compound C1 comprising at least one hydroxyl group is selected from the group consisting of hydroxyl group-containing (meth)acrylates.

5. The coating composition according to claim 1, wherein the ethylene copolymer comprises—in polymerized form and based on the total weight of the ethylene copolymer—from 1 to 70 wt. % of the at least one polymerizable compound C1 comprising at least one hydroxyl group, as determined by ¹H-NMR.

6. The coating composition according to claim 1, wherein the at least one polymerizable compound C2 comprising at least one epoxide group is selected from the group consisting of glycidyl acrylate and glycidyl methacrylate.

7. The coating composition according to claim 1, wherein the ethylene copolymer comprises—in polymerized form and based on the total weight of the ethylene copolymer—from 5 to 70 wt. of the at least one polymerizable compound C2 comprising at least one epoxide group, as determined by ¹H-NMR.

8. The coating composition according to claim 1, wherein the at least one polymerizable compound C3 is selected from the group consisting of alkyl (meth)acrylates.

9. The coating composition according to claim 1, wherein the ethylene copolymer comprises—in polymerized form and based on the total weight of the ethylene copolymer—from 5 to 75 wt. % of the at least one polymerizable compound C3, as determined by ¹H-NMR.

10. The coating composition according to claim 1, wherein the coating composition comprises the at least one binder B in a total amount of 10 to 60 wt. % based on a total weight of the coating composition.

11. The coating composition according to claim 1, wherein the coating composition is a clearcoat composition or a tinted clearcoat composition.

12. The coating composition according to claim 1, wherein the coating composition comprises 0 to 20 wt. % of water, based on a total weight of the coating composition.

13. A method for producing at least one coating on a substrate, the method comprising
(1) optionally applying a pigmented basecoat composition to the substrate, forming a coating film from said basecoat composition and optionally curing said basecoat film;
(2) applying the coating composition according to claim 1 to the substrate or the coated substrate obtained after step (1);
(3) forming a coating film from the composition applied in step (2); and
(4) curing the coating film(s) obtained after step (1) and/or (3).

14. A coating obtained by the method according to claim 13.

15. A method of using the coating composition according to claim 1, wherein the method comprises using the coating composition for improving the elongation and scratch resistance of coating layers.

16. The coating composition according to claim 1, wherein the ethylene copolymer comprises—in polymerized form and based on the total weight of the ethylene copolymer—from 25 to 65 wt. % of ethylene, as determined by ¹H-NMR.

17. The coating composition according to claim 1, wherein the at least one polymerizable compound C1 comprising at least one hydroxyl group is selected from the group consisting of hydroxy C₁-C₁₂ alkyl group-containing (meth)acrylates.

18. The coating composition according to claim 1, wherein the ethylene copolymer comprises—in polymerized form and based on the total weight of the ethylene copolymer—from 3 to 60 wt. % of the at least one polymerizable compound C1 comprising at least one hydroxyl group, as determined by ¹H-NMR.

19. The coating composition according to claim 1, wherein the at least one polymerizable compound C3 is selected from the group consisting of C₁-C₂₂ alkyl (meth)acrylates.

20. The coating composition according to claim 1, wherein the ethylene copolymer comprises—in polymerized form and based on the total weight of the ethylene copolymer—from 10 to 70 wt. % of the at least one polymerizable compound C3, as determined by ¹H-NMR.
